(19) United States
(12) Patent Application Publication
(10) Pub. No.: US 2023/0091523 A1
(43) Pub. Date: Mar. 23, 2023

(54) OPTICAL APPARATUS AND IMAGE DISPLAY APPARATUS

(71) Applicant: CANON KABUSHIKI KAISHA, Tokyo (JP)

(72) Inventor: Ryoji Kondo, Kanagawa (JP)

(21) Appl. No.: 17/932,848

(22) Filed: Sep. 16, 2022

(30) Foreign Application Priority Data
Sep. 21, 2021 (JP) 2021-153662

(51) Int. Cl. G02B 25/00; G06F 1/16

(52) U.S. Cl. CPC G02B 25/001; G06F 1/163

(57) ABSTRACT

An optical apparatus includes an eyepiece optical system including a first linear polarization plate and configured to guide light from an image display element to an eye of an observer, and a second linear polarization plate disposed outside an optical path from the image display element to the eye of the observer. The first linear polarization plate is disposed closest to the observer in the eyepiece optical system. A transmission axis direction of the first linear polarization plate and a transmission axis direction of the second linear polarization plate are different from each other.

### BACKGROUND

### Technical Field

The disclosure relates to an optical apparatus and an image display apparatus suitable for a head mount display (HMD) configured to magnify and observe an image on an image display element via an eyepiece optical system, or the like.

### Description of the Related Art

The image display apparatus that enlarges an image from the image display element (display) and presents it to an observer has been known. This image display apparatus is used for the HMD that includes the eyepiece optical system that magnifies the image displayed on the small image display element configured to display a two-dimensional image and presents it to the observer. Japanese Patent Laid-Open No. JP 2019-053152 discloses a polarization reflection type eyepiece optical system that includes at least one polarization beam splitter and folds an optical path utilizing polarization.

External light incident from a gap between the image display apparatus and the eye(s) of the observer may cause refraction and reflection in the eyepiece optical system, become light toward the eye of the observer again, and be reflected as ghosts and flares in the displayed image (external light ghost). JP 2017-195515 discloses an image display apparatus that includes a light shielding member for preventing the intrusion of the external light from the gap between the image display apparatus and the eye of the observer in order to prevent the external light ghost.

From the viewpoint of ensuring safety during the video experience, the observer may directly recognize the surroundings from the side(s) of the image display apparatus. The image display apparatus disclosed in JP 2017-195515 can prevent the external light ghost caused by the intrusion of the external light, but the observer cannot directly visually recognize the surroundings.

### SUMMARY

The disclosure provides an image display apparatus that enables an observer to visually recognize the surroundings while preventing an external light ghost.

An optical apparatus according to one aspect of the disclosure includes an eyepiece optical system including a first linear polarization plate and configured to guide light from an image display element to an eye of an observer, and a second linear polarization plate disposed outside an optical path from the image display element to the eye of the observer. The first linear polarization plate is disposed closest to the observer in the eyepiece optical system. A transmission axis direction of the first linear polarization plate and a transmission axis direction of the second linear polarization plate are different from each other. An image display apparatus according to another aspect of the disclosure includes the above optical apparatus, and an image display element.

Further features of the disclosure will become apparent from the following description of exemplary embodiments with reference to the attached drawings.

### BRIEF DESCRIPTION OF THE DRAWINGS

FIG. 1 is a configuration diagram of an image display apparatus according to each embodiment.

FIG. 2 is a configuration diagram of the image display apparatus according to each embodiment.

FIG. 3 is a configuration diagram of an eyepiece optical system according to a first embodiment.

FIG. 4 is a detailed configuration diagram of the eyepiece optical system according to the first embodiment.

FIG. 5 is a schematic view illustrating the image display apparatus according to each embodiment mounted on the head of an observer.

FIG. 6 illustrates a coordinate system according to each embodiment.

FIG. 7 is a schematic view illustrating the image display apparatus according to each embodiment mounted on the head of the observer.

FIG. 8 is a schematic view illustrating the image display apparatus according to each embodiment mounted on the head of the observer.

FIG. 9 is a configuration diagram of an eyepiece optical system according to a second embodiment.

### DESCRIPTION OF THE EMBODIMENTS

Referring now to the accompanying drawings, a detailed description will be given of embodiments according to the disclosure.

### First Embodiment

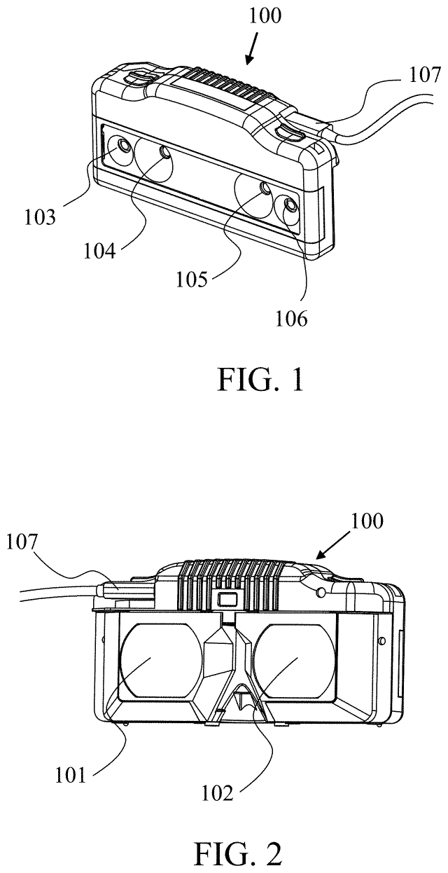

Referring now to FIGS. 1 and 2, a description will be given of an image display apparatus according to a first embodiment of the disclosure. FIGS. 1 and 2 are configuration diagrams of an image display apparatus 100. In FIGS. 1 and 2, reference numeral 101 denotes an eyepiece optical system for a left eye (or a left-eye eyepiece optical system), and reference numeral 102 denotes an eyepiece optical system for a right eye (or a right-eye eyepiece optical system). Reference numerals 103, 104, 105, and 106 denote cameras for external environment imaging, and are used for alignment and the like for drawing computer graphics. Reference numeral 107 denotes a cable for a video signal connected to a calculation unit such as an unillustrated personal computer.

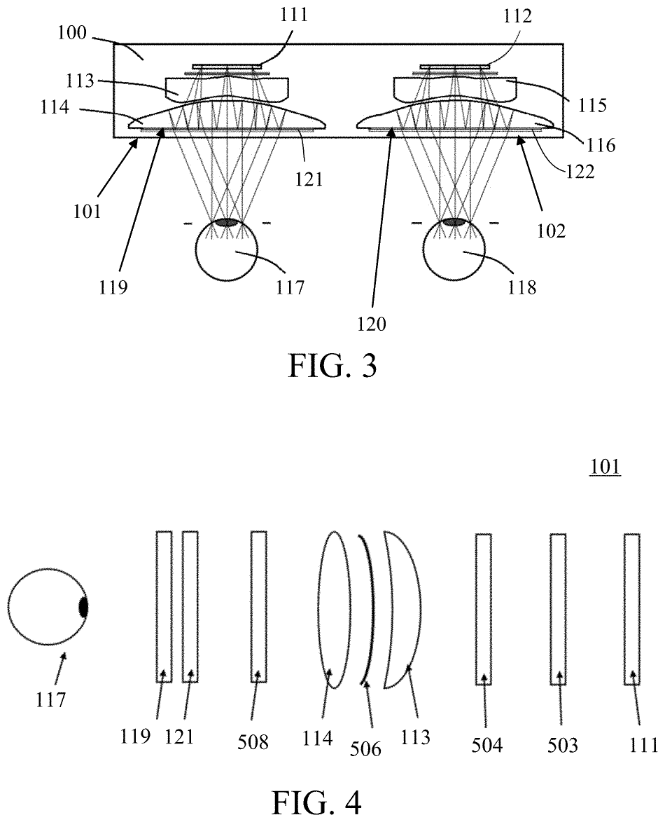

Referring now to FIG. 3, a description will be given of the eyepiece optical systems 101 and 102 according to this embodiment. FIG. 3 is a configuration diagram of the eyepiece optical systems 101 and 102. The eyepiece optical system 101 for the left eye of the observer includes an image display element 111 and optical lenses 113 and 114. The eyepiece optical system 102 for the right eye of the observer includes an image display element 112 and optical lenses 115 and 116. The image display elements 111 and 112 are, for example, organic EL displays, but are not limited to this example.

The eyepiece optical system 101 magnifies and projects as a virtual image an original image displayed on the image display element 111 and guides it to a left eye 117 of the observer. The eyepiece optical system 102 magnifies and projects as a virtual image an original image displayed on the image display element 112 and guides it to a right eye 118 of the observer. Each of the eyepiece optical systems 101 and 102 has a focal length of 12 mm, a horizontal display angle of view of 45°, a vertical display angle of view of 34°, and a diagonal display angle of view of 54°. A distance (eye relief) E1 between the image display apparatus 100 and each eyeball of the observer is 18 mm. The eyepiece optical system 101 includes at least one polarization beam splitter (PBS) 121, and the eyepiece optical system 102 includes at least one PBS 122, and each of the eyepiece optical systems 101 and 102 is a polarization reflection type optical system that folds an optical path by operating the polarization state. A light ray directed to the eye of the observer is linearly polarized light. The PBS 121 is disposed between the optical lens 114 and the first linear polarization plate 119 described below, and the PBS 122 is disposed between the optical lens 116 and the first linear polarization plate 120 described below, and each PBS is, but not limited to, a wire grid polarization element, for instance.

The eyepiece optical system 101 includes the first linear polarization plate 119, and the eyepiece optical system 102 includes the first linear polarization plate 120. In a case where the eyepiece optical systems 101 and 102 fold the optical paths utilizing the polarization reflection, the emitted light is linearly polarized. Therefore, an arrangement that makes the direction of the first linear polarization plate and the polarization direction of the emitted light coincide with each other can prevent the intensity of the image light viewed by the observer from lowering even if the first linear polarization plates 119 and 120 are disposed.

Referring now to FIG. 4, a description will be given of a detailed configuration of the eyepiece optical system 101. FIG. 4 is the detailed configuration diagram of the eyepiece optical system 101. While FIG. 4 illustrates only the right-eye eyepiece optical system, the configuration of the left-eye eyepiece optical system is similar to that of the right-eye eyepiece optical system and thus a description thereof will be omitted. The eyepiece optical system 101 includes, in order from a side of the image display element 111 to a side of the first linear polarization plate 119, a linear polarization plate 503, a quarter waveplate 504, an optical lens 113, a half-mirror 506, and an optical lens 114, and a quarter waveplate (second retardation plate) 508.

The light from the image display element 111 passes through the linear polarization plate (third linear polarization plate) 503 and the quarter waveplate (first retardation plate) 504 and becomes circularly polarized light. The circularly polarized light passes through the optical lens (first lens) 113, the half-mirror (semi-transmissive and reflective element) 506, the optical lens (second lens) 114, and the quarter waveplate (second retardation plate) 508, and becomes linearly polarized light. Since the direction of this linear polarized light is orthogonal to the transmission axis direction of the PBS (reflection type linear polarization plate) 121, this linearly polarized light is reflected, passes through the quarter waveplate 508 again to become circularly polarized light, passes through the optical lens 114, and is reflected on the half-mirror 506. The reflected circular polarized light becomes linearly polarized light on the quarter waveplate 508. Since the direction of this linear polarized light coincides with the transmission axis direction of the PBS 121, this linearly polarized light transmits the PBS 121 and the first linear polarization plate (absorption type linear polarization plate) 119 having the same transmission axis direction, and is guided to the left eye 117 of the observer. Since the first linear polarization plate 119 is disposed so as to prevent external light from being reflected by the PBS 121 and the transmission axis direction of the first linear polarization plate 119 and the transmission axis direction of the PBS 121 are equal to each other, the first linear polarization plate 119 does not affect the image light.

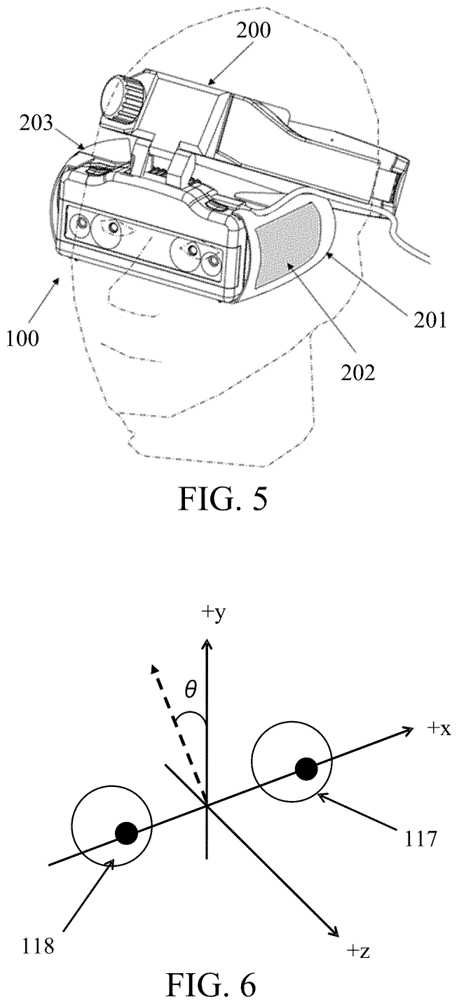

FIG. 5 is a schematic diagram illustrating the image display apparatus 100 mounted on the head of the observer. The image display apparatus 100 is mounted on the head of the observer by a mounting mechanism 200. The image display apparatus 100 is also referred to as a head mount display (HMD) in a case where it is mounted on the head.

Reference numeral 201 denotes a light shielding unit for the left eye, which restrains light from a light source different from the image display element from entering the optical system. A second linear polarization plate 202 is disposed outside the optical path from the image display element to the observer and provided to part of the light shielding unit 201. Part of the light shielding unit 201 other than the second linear polarization plate 202 includes a support member for holding the second linear polarization plate 202, which includes a member (light shielding member) that shields visible light. Reference numeral 203 denotes a light shielding unit for the right eye, which restrains light from a light source different from the image display element from entering the optical system. Similar to the light shielding unit 201, an unillustrated second linear polarization plate is provided to part of the light shielding unit 203. Part of the light shielding unit 203 other than the second linear polarization plate includes a support member for holding the second linear polarization plate, which includes a member (light shielding member) that shields visible light.

FIG. 6 is a schematic diagram illustrating a coordinate system for representing the direction of the linearly polarized light. X-axis is set to an axis in a direction connecting the left eye 117 and the right eye 118 of the observer, z-axis is set to an axis in a direction in which the observer views the image, and y-axis is set to an axis in a direction orthogonal to the x-axis and the z-axis. In this embodiment, the first linear polarization plate 119 has a characteristic of transmitting light polarized in the x-axis direction and of not transmitting light polarized in the y-axis direction. The second linear polarization plate 202 formed on the light shielding unit 201 has a characteristic of transmitting light polarized in the y-axis direction and of not transmitting light polarized in the x-axis direction. That is, an angle (transmission axis angle α) formed between the polarization transmission direction (transmission axis direction) of the first linear polarization plate 119 and the polarization transmission direction of the second linear polarization plate 202 is 90 degrees (two linear polarization plates have the polarization transmission directions that are approximately orthogonal to each other). However, the transmission axis angle α in this embodiment is not limited to 90 degrees as long as the polarization transmission direction of the first linear polarization plate 119 and the polarization transmission direction of the second linear polarization plate 202 are different from each other. That is, in this embodiment, where angles formed in a case where two linear polarization plates are arranged on the same axis (in a case where the transmission axis directions are projected on the same plane) are compared in local coordinates (two-dimensionally compared), the transmission axis directions are different from each other. If these angles are different in the three-dimensional comparison but are equal in the two-dimensional comparison, they are out of an applicable range of this embodiment.

The first linear polarization plate 119 and the second linear polarization plate 202 are disposed at positions spatially separated from each other. Therefore, the angle formed by the transmission axis direction of the first linear polarization plate 119 and the transmission axis direction of the second linear polarization plate 202 can be obtained by projecting the transmission axis direction of the second linear polarization plate 202 onto the plane (such as the xy plane in FIG. 6) that includes the first linear polarization plate 119. In FIG. 6, a direction in a case where the transmission axis direction of the second linear polarization plate 202 is projected onto the xy plane is illustrated by a broken line. By using an angle θ between the direction of the broken line and the y-axis direction, the angle (transmission axis angle α) between the transmission axis direction of the first linear polarization plate 119 and the transmission axis direction of the second linear polarization plate 202 can be expressed as α=90±θ (degrees). For example, in the case where the angle θ is 10 degrees, the transmission axis angle α is 100 degrees or 80 degrees.

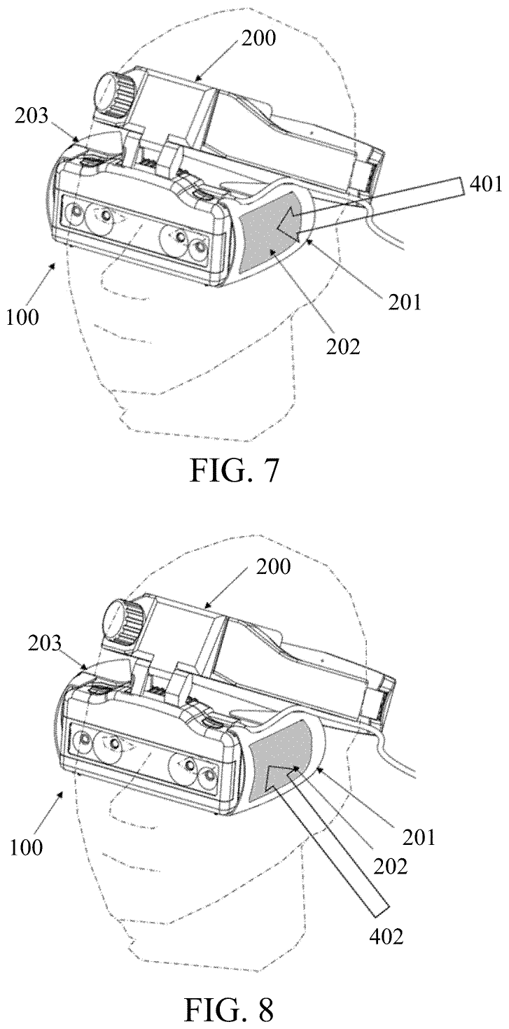

As illustrated in FIG. 7, part of light 401 from the outside of the observer to the eyepiece optical system 101 through the vicinity of the light shielding unit 201 is shielded by the light shielding unit 201. On the other hand, another part of the light 401 passes through the second linear polarization plate 202, becomes light polarized in the y-axis direction, and heads toward the eyepiece optical systems 101 and 102. Light polarized in the y-axis direction at an angle of 90 degrees with the transmission direction of the first linear polarization plate 119 cannot enter the eyepiece optical systems 101 and 102 and does not become an external light ghost.

On the other hand, as illustrated in FIG. 8, light 402 from the outside of the observer to the eye of the observer through the vicinity of the light shielding unit 201 is dimmed in almost halves by the second linear polarization plate 202 but can reach the eye of the observer, and thus the observer can directly visually recognize the outside. Since the light shielding unit 203 on the right-eye side similarly works, the observer can directly visually recognize the outside on the right and left sides of the image display apparatus 100.

In this embodiment, the second linear polarization plate 202 is formed as part of the light shielding unit 201, but the entire light shielding unit 201 may be formed as the linear polarization plate. The effect of this embodiment can be acquired as long as the polarization transmission directions of the first linear polarization plates 119 and 120 and the polarization transmission directions of the second linear polarization plates 202 are different from each other. A relationship between the angle (transmission axis angle α) formed between the first linear polarization plates 119 and 120 and the second linear polarization plates 202 and the transmission light intensity is expressed by cos² α using the transmission axis angle α. The transmission axis angle α set to an angle within a range of 70 degrees or more and 110 degrees or less is particularly effective, because a light amount of intruding external light can be reduced down to about 10% or more. As long as the transmission axis angle α is set to an angle within a range of 80 degrees or more and 100 degrees or less, the ghost preventive effect becomes high because the transmission light intensity is reduced down to about 3%. The transmission axis angle α may be 90 degrees (the transmission axis directions of the two linear polarization plates may be approximately orthogonal to each other).

In this embodiment, each of the eyepiece optical systems 101 and 102 has an eye relief of 18 mm, but if the eye relief is longer than a predetermined length, external light is likely to intrude. Therefore, this embodiment is particularly effective in an image display apparatus having an eyepiece optical system having an eye relief of 10 mm or more.

In this embodiment, the first linear polarization plates 119 and 120 are disposed at the positions closest to the eyes in the eyepiece optical systems 101 and 102, but the disclosure is not limited to this example. The external light ghost can be prevented as long as the first linear polarization plates 119 and 120 are located on the eye side of the reflective surface and the refraction surface which are the main causes of returning the external light ghost to the eyes of the observer in the eyepiece optical systems 101 and 102.

### Second Embodiment

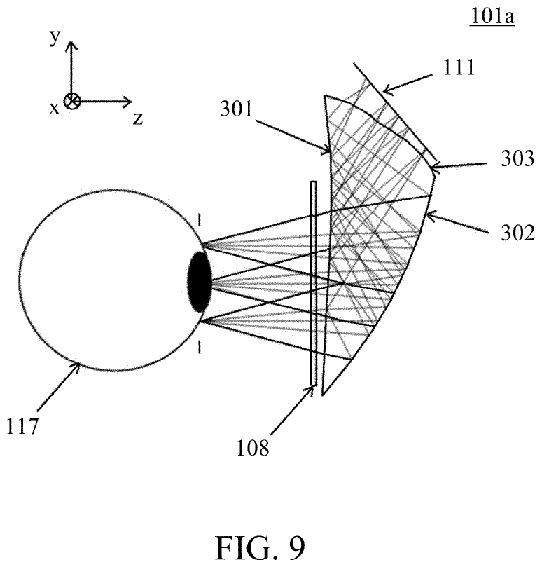

Referring now to FIG. 9, a description will be given of an image display apparatus according to a second embodiment of this disclosure. This embodiment is different from the first embodiment in the configuration of the eyepiece optical system. In this embodiment, other basic configurations of the image display apparatus are the same as those in the first embodiment, and thus a description thereof will be omitted.

FIG. 9 is a configuration diagram of an eyepiece optical system 101a for the left eye in this embodiment, which is an eyepiece optical system using an eccentric prism. The coordinate system is common to that illustrated in FIG. 6. The prism is molded with optical plastic having optical surfaces 301, 302, and 303. Light from the image display element 111 enters the prism through the optical surface 303, is totally internally reflected by the optical surface 301 toward the optical surface 302, is reflected by the metal-deposited optical surface 302, and is refracted from the optical surface 301 toward the left eye 117 of the observer.

Reference numeral 108 denotes a first linear polarization plate. Even in the eyepiece optical system 101a according to this embodiment, there is an optical path that causes an external light ghost when external light intrudes. However, similar to the first embodiment, the eyepiece optical system 101a includes the first linear polarization plate 108. Therefore, the combination of the second linear polarization plate 202 and the light shielding unit 201 enables the observer to visually recognize the outside through the side surfaces of the image display apparatus 100 while suppressing the external light ghost.

Each embodiment can provide an image display apparatus that enables an observer to visually recognize the surroundings while preventing an external light ghost.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2021-153662, filed on Sep. 21, 2021, which is hereby incorporated by reference herein in its entirety.

What is claimed is:

1. An optical apparatus comprising:
an eyepiece optical system including a first linear polarization plate and configured to guide light from an image display element to an eye of an observer; and
a second linear polarization plate disposed outside an optical path from the image display element to the eye of the observer,
wherein the first linear polarization plate is disposed closest to the observer in the eyepiece optical system, and
wherein a transmission axis direction of the first linear polarization plate and a transmission axis direction of the second linear polarization plate are different from each other.

2. The optical apparatus according to claim 1, wherein an angle formed between the transmission axis direction of the first linear polarization plate and the transmission axis direction of the second linear polarization plate is 70 degrees or more and 110 degrees or less.

3. The optical apparatus according to claim 1, further comprising a light shielding unit configured to restrain light from a light source different from the image display element from entering an optical system.

4. The optical apparatus according to claim 3, wherein the second linear polarization plate is held by the light shielding unit.

5. The optical apparatus according to claim 1, wherein the eyepiece optical system includes, in order from a side of the image display element to a side of the first linear polarization plate, a third linear polarization plate, a first retardation plate, a first lens, and a semi-transmissive and reflective element, a second lens, and a second retardation plate.

6. The optical apparatus according to claim 1, wherein the eyepiece optical system includes a polarization beam splitter disposed between the image display element and the first linear polarization plate.

7. The optical apparatus according to claim 1, wherein the eyepiece optical system has an eye relief of 10 mm or more.

8. An image display apparatus comprising:
an optical apparatus; and
an image display element,
wherein the optical apparatus includes:
an eyepiece optical system including a first linear polarization plate and configured to guide light from the image display element to an eye of an observer; and
a second linear polarization plate disposed outside an optical path from the image display element to the eye of the observer,
wherein the first linear polarization plate is disposed closest to the observer in the eyepiece optical system, and
wherein a transmission axis direction of the first linear polarization plate and a transmission axis direction of the second linear polarization plate are different from each other.
